(19) United States
(12) Patent Application Publication
(10) Pub. No.: US 2023/0189039 A1
(43) Pub. Date: Jun. 15, 2023

(54) Beam Failure Recovery in Secondary Cell Activation

(71) Applicant: NOKIA Technologies OY, Espoo (FI)

(72) Inventors: Samuli TURTINEN, Ii (FI); Chunli WU, Beijing (CN); Tero HENTTONEN, Espoo (FI); Timo KOSKELA, Oulu (FI)

(21) Appl. No.: 17/926,037

(22) PCT Filed: May 21, 2020
(86) PCT No.: PCT/CN2020/091518

§ 371 Date: Nov. 17, 2022

(51) Int. Cl. H04W 24/10; H04W 16/28

(52) U.S. Cl. CPC H04W 24/10; H04W 16/28

(57) ABSTRACT

Example embodiments relate to wireless communication devices, methods and systems for beam failure recovery (BFR) in a cell activation procedure. According to an embodiment, a method for cell activation includes receiving, at a terminal device (UE), a first indication from a network to activate a cell configured for the UE, and responsive to the first indication, triggering a beam information reporting for the cell.

### TECHNICAL FIELD

Exemplary embodiments described herein generally relate to communication technologies, and more particularly, to wireless communication devices, methods and systems for beam failure recovery (BFR) in a secondary cell activation procedure.

### BACKGROUND

Certain abbreviations that may be found in the description and/or in the figures are herewith defined as follows:

| | |
|---|---|
| BFD BFI BFR CA DC gNB MAC MAC CE MCG MIMO NR PCell PSCell RRC SCell SCG SpCell UE | Beam Failure Detection Beam Failure Instance Beam Failure Recovery Carrier Aggregation Dual Connectivity 5G Node-B Medium Access Control MAC Control Element Master Cell Group Multiple Input Multiple Output New Radio Primary Cell Primary Secondary Cell Radio Resource Control Secondary Cell Secondary Cell Group Special Cell, i.e., PCell or PSCell User Equipment |

5G New Radio (NR) utilizes a number of frequency bands within ranges known as First Frequency Range (FR1) below 7.125 GHz and Second Frequency Range (FR2) from about 24 GHz to 86 GHz. The FR2, also referred to as mmWave, can support services that require a very high data rate and an ultra low latency, because of its high frequency. However, the mmWave has a high path loss caused by molecule absorption of the electro-magnetic wave and thus it cannot travel a long distance. In addition, an antenna for the mmWave is very small with insufficient area (aperture) for receiving radiation energy.

Massive Multiple Input Multiple Output (MIMO) and beamforming have been suggested to overcome issues relating to the mmWave. The massive MIMO technique use dozens or hundreds of individual antennas arranged in an array, which greatly increases the antenna area for receiving the radiation energy. When multiple antennas in the antenna array transmit the same signal at an identical wavelength and phase, they create a narrow radiation beam oriented in a specific direction. This is the so called beamforming, which can increase coverage and reduce interference because the radiation beam becomes much narrower.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for more detailed description provided below.

In a first aspect, an example embodiments of a method for cell activation is provided. The method may comprise receiving, at a terminal device (UE), a first indication from a network to activate a cell configured for the UE, and responsive to the first indication, triggering a beam information reporting for the cell.

In a second aspect, an example embodiment of a method for cell activation is provided. The method may comprise sending from a network (NW) to a terminal device (UE) a first indication to activate a cell configured for the UE, and receiving from the UE a beam failure recovery (BFR) medium access control (MAC) control element (CE) comprising a candidate reference signal (RS) identity for the cell. The candidate RS identity may comprise an index of a Synchronization Signal and Physical Broadcast Channel block (SSB) for the cell, or one of the index of the SSB for the cell or an index of an RS included in a candidate RS list provided from the network to the UE. The BFR MAC CE may further comprise a second indication to indicate if the SSB index or the candidate RS list index is used as the candidate RS identity. The method may further comprise decoding the candidate RS identity in the BFR MAC CE.

In a third aspect, an example embodiment of a terminal device is provided. The terminal device may comprise at least one processor and at least one memory including computer program code. The at least one memory and the computer program code may be configured to, with the at least one processor, cause the terminal device at least to perform receiving a first indication from a network to activate a cell configured for the terminal device, and responsive to the first indication, triggering a beam information reporting for the cell.

In a fourth aspect, an example embodiment of a network device is provided. The network device may comprise at least one processor and at least one memory including computer program code. The at least one memory and the computer program code may be configured to, with the at least one processor, cause the network device at least to perform sending to a terminal device (UE) a first indication to activate a cell configured for the UE, receiving from the UE a beam failure recovery (BFR) medium access control (MAC) control element (CE) comprising a candidate reference signal (RS) identity for the cell, and decoding the candidate RS identity in the BFR MAC CE. The candidate RS identity may comprise an index of a Synchronization Signal and Physical Broadcast Channel block (SSB) for the cell, or one of the index of the SSB for the cell or an index of an RS included in a candidate RS list provided from a network to the UE. The BFR MAC CE may further comprise a second indication to indicate if the SSB index or the candidate RS list index is used as the candidate RS identity.

In a fifth aspect, an example embodiment of an apparatus for cell activation is provided. The apparatus may comprise means for receiving, at a terminal device (UE), a first indication from a network to activate a cell configured for the UE, and means for, responsive to the first indication, triggering a beam information reporting for the cell.

In a sixth aspect, an example embodiment of an apparatus for cell activation is provided. The apparatus may comprise means for sending from a network (NW) to a terminal device (UE) a first indication to activate a cell configured for the UE, means for receiving from the UE a beam failure recovery (BFR) medium access control (MAC) control element (CE) comprising a candidate reference signal (RS) identity for the cell, and means for decoding the candidate RS identity in the BFR MAC CE. The candidate RS identity may comprise an index of a Synchronization Signal and Physical Broadcast Channel block (SSB) for the cell, or one of the index of the SSB for the cell or an index of an RS included in a candidate RS list provided from the network to the UE. The BFR MAC CE may further comprising a second indication to indicate if the SSB index or the candidate RS list index is used as the candidate RS identity.

In a seventh aspect, an example embodiment of a computer readable medium is provided. The computer readable medium has instructions stored thereon. The instructions, when executed by at least one processor of a device, cause the device to perform any one of the methods discussed above.

### BRIEF DESCRIPTION OF THE DRAWINGS

Some example embodiments will now be described, by way of non-limiting examples, with reference to the accompanying drawings.

FIG. 1 illustrates a schematic diagram of an example communication system in which embodiments of the present disclosure can be implemented.

FIG. 2 illustrates a process of cell activation according to some embodiments of the present disclosure.

FIG. 3 illustrates a process of determining conditions to trigger a beam information reporting according to some embodiments of the present disclosure.

FIG. 4 illustrates an example of a beam failure recovery (BFR) medium access control (MAC) control element (CE) according to some embodiments of the present disclosure.

FIG. 5 illustrates a process of cell activation according to some embodiments of the present disclosure.

FIG. 6 illustrates a block diagram of an example communication system in which embodiments of the present disclosure can be implemented.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

As used herein, the term “network device” refers to any suitable entities or devices that can provide cells or coverage, through which the terminal device can access the network or receive services. Examples of the network device can include a base station. The term “base station” used herein can represent a node B (NodeB or NB), an evolution node B (eNodeB or eNB), gNB, a remote radio unit (RRU), a radio frequency head (RH), a remote radio head (RRH), a relay, or low power nodes such as pico base station or femto base station and so on.

As used herein, the term “terminal device” or “user equipment” (UE) refers to any entities or devices that can wirelessly communicate with the network devices or with each other. Examples of the terminal device can include a mobile terminal (MT), a subscriber station (SS), a portable subscriber station (PSS), a mobile station (MS), or an access terminal (AT), the above devices mounted on vehicles, and machines or electric appliances having communication functions etc.

The term “include” and its variants are to be read as open-ended terms that mean “includes, but is not limited to.” The term “based on” is to be read as “based at least in part on.” The term “one embodiment” is to be read as “at least one embodiment.” The term “a further embodiment” is to be read as “at least a further embodiment.” Definitions related to other terms will be described in the following description.

FIG. 1 illustrates a schematic diagram of an example communication system 100 in which exemplary embodiments of the present disclosure can be implemented. Referring to FIG. 1, the system 100 includes a terminal device or user equipment (UE) 110 in communication with a network device such as a base station 120. For the sake of convenience, gNB will be described hereinafter as an example of the network device, but it would be appreciated that the network device is not limited thereto.

In some embodiments, the UE 110 may operate in a carrier aggregation (CA) mode. In the CA mode, multiple component carriers (CCs) operated by the gNB 120 may be aggregated on the UE 110 as a wider band to achieve a higher data rate. FIG. 1 shows a primary CC (PCC) 11 serving a primary cell (PCell) and a secondary CC (SCC) 12 serving a secondary cell (SCell). The PCell is a cell where the UE 110 performs an initial Radio Resource Control (RRC) connection establishment procedure or initiates an RRC connection re-establishment procedure. Once the RRC connection is established, one or more SCells may be configured for the UE 110. The configured SCell may be activated or deactivated as required. For example, when a large volume of data needs to be delivered to the UE 110 or when the PCell is fully loaded, the network can activate one or more SCells to transmit downlink data to the UE 110; when there is no more data to be delivered to the UE 110 or when the SCell has poor channel quality, the network can deactivate the SCell to save power consumption. The SCell activation/deactivation may be done by means of Medium Access Control Control Element (MAC CE) or by means of Radio Resource Control (RRC) signaling.

The communication system 100 may further comprise a network device such as a base station 130, which is also shown as gNB in FIG. 1 but it is not limited thereto. It would be understood that the base stations 120, 130 may be of different types. For example, one or both of the base stations 120, 130 may be an eNB. In some embodiments, the UE 110 may simultaneously communicate with both the gNB 120 and the gNB 130 in a dual connectivity mode. In such a case, one of the base stations 120, 130 may operate as a master NodeB and the other may operate as a secondary NodeB. For the sake of convenience, herein the gNB 120 is described as the master NodeB (MgNB) and the gNB 130 is described as a secondary NodeB (SgNB).

Similar to the gNB 120, multiple CCs operated by the gNB 130 (SgNB) may also be aggregated on the UE 110. FIG. 1 shows a PCC 21 serving a primary secondary cell (PSCell) and an SCC 22 serving a secondary cell (SCell). The serving cells of the SgNB 130 may be collectively referred to as a secondary cell group (SCG), and the serving cells of the MgNB 120 may be collectively referred to as a master cell group (MCG). The PSCell is a primary cell for the SCG and it is configured with a physical uplink control channel (PUCCH), and the SCell(s) of the SCG may be configured with or without the PUCCH. The PCell of the MCG and the PSCell of the SCG may also be referred to as a special cell (SpCell). Similar to the SCells in the MCG, the SCell(s) of the SCG may also be activated or deactivated.

Signal transmission and reception between the UE 110 and the base stations 120, 130 may be performed by beamforming as mentioned above, no matter the serving cells (including the SpCells and the SCells) operate in FR1 or FR2 frequency bands, in order to increase coverage and improve spectrum efficiency. The UE 110 may manage and control the beams by a beam management mechanism. In particular, the UE 110 may monitor quality of the beams by detecting beam failure detection reference signals (BFD-RSs), which may be Synchronization Signal and PBCH blocks (SSBs) or Channel State Information reference signals (CSI-RSs). If a BFD-RS associated with a beam has a quality lower than a configured value, the UE 110 determines a beam failure instance (BFI) indication and increments a BFI counter by one. When the number of consecutive detected BFIs exceeds a maximum value, the UE 110 declares a beam failure event and triggers a beam failure recovery (BFR) procedure to configure a new serving beam for the SCell.

When a SCell is deactivated, the UE 110 considers the BFR procedure for the SCell successfully completed, cancel all the triggered BFR procedures for the SCell, and set the BFI counter to zero. During the time when the SCell is deactivated, the UE does not perform beam failure detection for the SCell. Then when the SCell is activated, the UE 110 would start performing the beam failure detection and monitor the beams on the SCell. However, as beam management is not performed for the deactivated SCell, the serving beams for the SCell may not be valid anymore. On the other hand, the UE 110 would not declare a beam failure until the number of BFI indications it receives from lower layers reaches the maximum value. It would take unnecessarily long time and SCell deactivation would not make much sense from the system point of view.

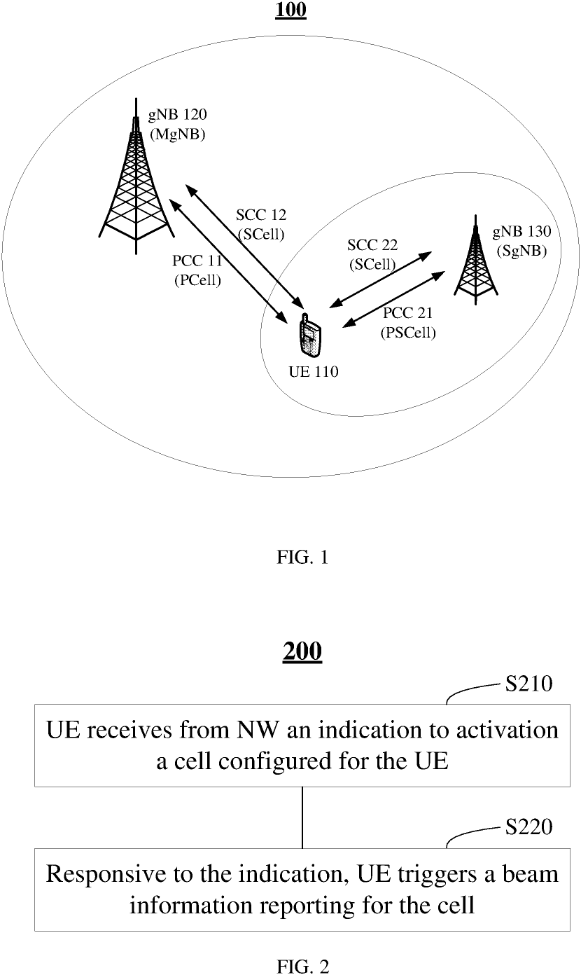

FIG. 2 illustrates a process 200 of cell activation according to some embodiments of the present disclosure. The process 200 may be implemented at a terminal device such as the UE 110. The UE 110 may be configured with software or hardware modules for implementing the process 200. By implementation of the process 200, fast beam synchronization may be achieved when a cell is activated and unnecessary time for receiving the maximum number of BFI indications may be avoided.

Referring to FIG. 2, the process 200 may begin with Step 210 where the UE 110 receives an indication from the network to activate a cell configured for the UE 110. The cell to be activated may be an SCell in the MCG or in the SCG. If the SCell to be activated is from the MCG, the indication to activate the SCell may be received from the MgNB 120; if the SCell to be activated is from the SCG, the indication to activate the SCell may be received from the SgNB 130. The network may send the indication to the UE 110 by radio resource control (RRC) signaling or medium access control (MAC) control element (CE).

In some embodiments, the network may send the indication to activate the SCell to the UE 110 when the network configures the SCell for the UE 110 via RRC signaling. The network may encode the indication in an implicit or explicit manner in the SCell configuration sent to the UE 110. For example, the network may instruct the UE 110 to activate the SCell once the SCell is configured. In some embodiment, the network may send an SCell activation MAC CE to the UE 110 to activate an SCell already configured for the UE 110.

Upon receiving the indication to activate the SCell, the UE 110 may activate the SCell by applying normal SCell operations including for example sounding reference signal (SRS) transmissions on the SCell, CSI reporting for the SCell, activation of DL/UL bandwidth parts (BWPs) for the SCell, and so on.

Referring to FIG. 2, at Step S220, responsive to the indication to activate the SCell, the UE 110 may trigger a beam information reporting for the activated SCell. In such embodiments, the UE 110 may directly report beam information of the SCell to the network when the SCell is activated, but does not need to receive the number of BFI indications before reporting the beam information of the SCell. Thus, the network may synchronize the beam configuration for the activated SCell with the UE 110 quickly and unnecessarily long time for detection of the number of BFI indications may be avoided.

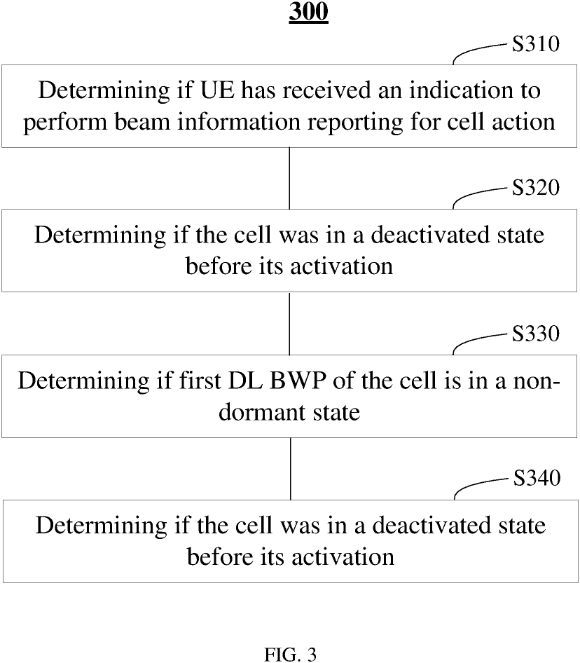

In some embodiments, the UE 110 may trigger the beam information reporting for the activated SCell under some certain conditions responsive to the SCell activation. FIG. 3 illustrates a process 300 of determining conditions to trigger a beam information reporting according to some embodiments of the present disclosure, and the process 300 may be implemented at for example the UE 110. It would be appreciated that steps shown in FIG. 3 are described as examples, and the UE 110 does not have to perform all the steps or perform the steps in the described order.

Referring to FIG. 3, at Step 310, the UE 110 may determine if it has received an indication from the network to perform the beam information reporting for the activated cell. For example, when the network configures an SCell for the UE 110 via RRC signaling, it may indicate the UE 110 to activate the SCell and perform the beam information reporting for the activated SCell. For another example, when the network sends a SCell activation command to the UE 110 via a SCell activation/deactivation MAC CE, it may indicate the UE 110 to perform the beam information reporting for the activated SCell. For example, this indication may be implicit for each SCell to be activated based on the SCell activation/deactivation MAC CE, or it may be explicitly indicated in the MAC CE. The network may also provide in a BFR configuration for the UE 110 that the beam information reporting should be performed for the SCell activation. The network may trigger the beam information reporting of the UE when it detects by for example un-responded scheduling commands, SRS signals etc. that the downlink beam for the SCell has likely failed. If the UE 110 determines in Step 310 that it has received the indication to perform the beam information reporting from the network, it may trigger the beam information reporting for the activated SCell. For example, if the UE 110 determines in Step 310 that it has received the indication to perform the beam information reporting from the network, it may trigger the beam information reporting for the activated SCell even in case it is determined by the UE 110 that the SCell was in activated state before receiving the indication.

In some embodiments, the network may configure the indication to perform the beam information reporting on a per cell basis, a per cell group basis or a per UE basis. If the indication is configured on a per cell basis, the UE 110 would trigger the beam information reporting for a designated cell when it is activated; if the indication is configured on a per cell group basis, the UE 110 would trigger the beam information reporting for each cell in the designated cell group (e.g., the MCG or the SCG) when the cell is activated except if the activation cannot be applied to the cell for example a SpCell; if the indication is configured on a per UE basis, the UE 110 would trigger the beam information reporting for each serving cell of the UE 110 when the cell is activated except if the activation cannot be applied to the serving cell, for example a SpCell.

At Step 320, the UE 110 may determine if the cell to be activated was in a deactivated state before the activation thereof. The SCell activation/deactivation MAC CE received from the network may comprise one or four octets, of which the first octet may comprise seven C fields (Cᵢ) and one reserved field (R), and the remaining three octets each may comprise eight C fields (Cᵢ). The Cᵢ field may be set to 1 to indicate an SCell with the SCell index i shall be activated or to 0 to indicate the SCell shall be deactivated. UE may receive an SCell activation/deactivation MAC CE activating an SCell while the SCell was already active. In such a case, the UE 110 may unnecessarily trigger the beam information reporting for the already active SCell. To avoid the unnecessary beam information reporting, at Step 320, the UE 110 determines if the cell to be activated was in the deactivated state before the activation thereof. If yes, the UE 110 would trigger the beam information reporting for the SCell activation. Otherwise, the UE 110 would not trigger the beam information reporting for the SCell activation.

At Step 330, the UE 110 may determine if a first active downlink (DL) bandwidth part (BWP) of the cell to be activated is in a non-dormant state or is a BWP that is not dormant BWP or is a non-dormant BWP. If the first active DL BWP of the cell is a dormant BWP, it may indicate that the network does not have data transmission scheduling on the cell and thus the UE 110 may not need to rush to report the beam information of the cell to the network. For example, if the first active DL BWP of the cell to be activated is a dormant BWP, the UE 110 may not trigger the beam information reporting of the cell to the network. Instead, the UE 110 may perform beam failure detection for the cell. When a number of BFI indications are received and a beam failure event is declared for the cell, the UE 110 will report the beam information of the cell to the network. On the other hand, if the first active DL BWP of the cell to be activated is not a dormant BWP or is a non-dormant BWP, the UE 110 may trigger the beam information reporting for the cell to be activated in order to achieve fast beam synchronization for the cell.

At Step 340, the UE 110 may determine if a reference signal for beam failure detection (BFD RS) is configured on the cell to be activated. In some cases, the cell to be activated may share a beam with a second cell (PCell, PSCell or SCell). If the BFD RS for the beam is configured on the second cell and the second cell is active and is not in a beam failure state, the UE 110 would not trigger the beam information reporting for the activated cell. On the other hand, if the BFD RS is configured on the cell to be activated, the UE 110 would trigger the beam information upon activation of the cell.

It would be understood that the UE 110 may not perform all the steps 310 to 340. If any one or more of the above conditions are determined, the UE 110 may trigger the beam information reporting for the cell to be activated. For example, if the first active DL BWP of the cell to be activated is the dormant BWP and the network wants to move the cell quickly from the dormant BWP to a non-dormant BWP soon after the cell activation, the network may send an explicit indication to trigger the beam information reporting in the cell activation MAC CE to the UE 110. Responsive to the explicit indication, the UE 110 would trigger the beam information reporting for the cell even though the first active DL BWP of the cell is the dormant BWP.

When the UE 110 triggers the beam information reporting for the activated cell, the UE 110 may report the beam information of the activated cell by means of a beam failure recovery (BFR) procedure by sending a BFR MAC CE to the network for the activated cell. For example, responsive to the activation of a cell or upon activation of a cell, the UE 110 may trigger BFR for the activated cell. In another example, based on the triggered BFR, the beam failure information may be reported by sending a BFR MAC CE to the network. In another example, in case the UE 110 determines that at least one BFR has been triggered and not cancelled and if it is determined that UL-SCH resources are not available for a new transmission to transmit BFR MAC CE to the network, the UE 110 may trigger a Scheduling Request procedure for beam failure recovery.

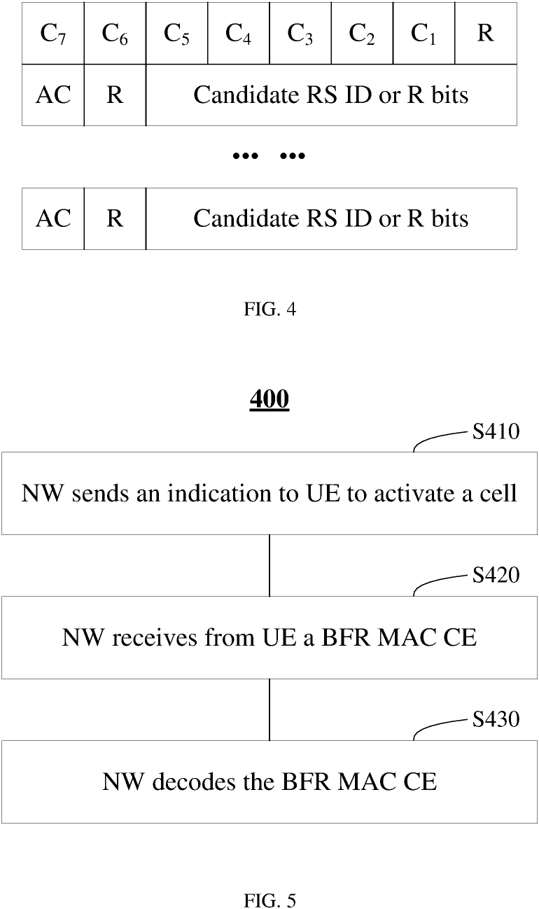

FIG. 4 illustrates an example of the BFR MAC CE according to some embodiments of the present disclosure. Referring to FIG. 4, the BFR MAC CE may comprise a bitmap of one or four octets (one octet is shown in FIG. 4) and BFR information octets for SCells indicated in the bitmap.

The Cᵢ field in the bitmap indicates beam failure detection status and the presence of the BFR information octet for the SCell with an SCell index i or with a Serving Cell index i (e.g., ServCelllndex). If the Cᵢ field is set to 1, it indicates that the SCell with the index i has experienced a beam failure and the BFR information octet for the SCell is present or may be present. If the Cᵢ field is set to 0, it indicates that the SCell with the index i has not experienced a beam failure and the BFR information octet for the SCell is not present. The BFR information octets are included in ascending order based on the SCell index i and each octet comprises a candidate beam availability indication (AC) and a candidate RS identity (ID) if available. The AC field indicates the presence of the candidate RS ID field in this octet. If the AC field is set to 1, the candidate RS ID field is present; otherwise, R bits are present instead. R represents a reserved bit.

When the SCell is deactivated, no active beam management is necessarily performed for the SCell. Then when the SCell is activated, the serving beams for the SCell may not be valid any more, and the network may not be able to provide the UE 110 with a proper list of candidate beam RS IDs associated with the location where the UE 110 is in the cell upon activation of the cell. In view of the fact, the UE 110 may consider all Synchronization Signal and PBCH blocks (SSBs) of the activated SCell as candidate beams for the activated SCell. In some embodiments, the candidate RS ID field in the BFR MAC CE may be selected from only the SSBs of the activated SCell having a reference signal received power (RSRP) above a threshold, and the candidate beam RS ID list provided from the network to the UE 110 may be ignored. In some other embodiments, the candidate RS ID field in the BFR MAC CE may be selected from the SSBs or the candidate RS ID list provided by the network for the activated SCell having a reference signal received power (RSRP) above a threshold. In the latter case, the BFR MAC CE may further include an indicator, e.g. the R bit in the BFR information octet, to indicate which of the SSBs of the SCell or the candidate RS ID list provided by the network is used as the candidate RS ID in the BFR MAC CE so that the network can decode it successfully.

In some embodiments, if the serving beam for the activated SCell is still valid, the serving beam is preferably included as the candidate RS ID in the BFR MAC CE and provided to the network. If the network receives the serving beam, it may continue to schedule the activated SCell on the serving beam. If the serving beam becomes invalid and the network receives a new candidate beam for the activated SCell, the network will update the serving beam of the SCell with the new candidate beam and then schedule the SCell on the new beam.

In some embodiments, the UE 110 may ignore any scheduling grant from the activated SCell before the BFR MAC CE has been transmitted, if the beam information reporting is triggered. Since the BFR MAC CE is transmitted, the network knows from the BFR MAC CE when the SCell is again available, and the UE 110 may operate according the scheduling grants from the activated SCell.

FIG. 5 illustrates a process 400 of cell activation according to some embodiments of the present disclosure. The process 400 may be implemented at a network device such as the gNBs 120, 130 shown in FIG. 1. The network device may be configured with software or hardware modules for implementing of the process 400. By implementation of the process 400, fast beam synchronization may be achieved between the UE and the network device when a cell is activated for the UE and unnecessary time for receiving multiple BFI indications may be avoided. Some details of the process 400 are apparent from the above description with reference to the process 200 shown in FIG. 2, and herein the process 400 will be described briefly.

Referring to FIG. 5, at Step 410, the network sends an indication to the UE 110 to activate a cell for example an SCell configured for the UE. As described above, the indication may be sent to the UE 110 in a cell activation command via MAC CE or in a cell configuration via RRC signaling.

At Step 420, the network receives a BFR MAC CE for the activated cell from the UE 110. In some embodiments, the BFR MAC CE may include fields shown in FIG. 4. In particular, the BFR MAC CE may comprise a candidate RS ID for the activated cell. In some embodiments, the candidate RS ID may comprise an index of SSB for the cell. In some embodiments, the candidate RS ID may comprise one of the SSB index or an index of an RS selected from a candidate RS list provided from the network to the UE 110, and the BFR MAC CE may further comprise an index indicator to indicate which of the SSB index and the RS index selected from the RS list provided by the network is used in the BFR MAC CE.

At Step 430, the network may decode the BFR MAC CE. In particular, the network may know the index space indicated by the index indicator and successfully decode the candidate RS ID in the BFR MAC CE. As discussed above, the BFR MAC CE may initiate a BFR procedure for the activated cell.

In some embodiments, before or at the time of sending the indication to activate a cell at Step 410, the network may further send an indication to the UE 110 to trigger a beam information reporting for the cell activation. As discussed above, the indication to trigger the beam information reporting may be sent in a cell activation command, a cell configuration or a BFR configuration for the UE 110.

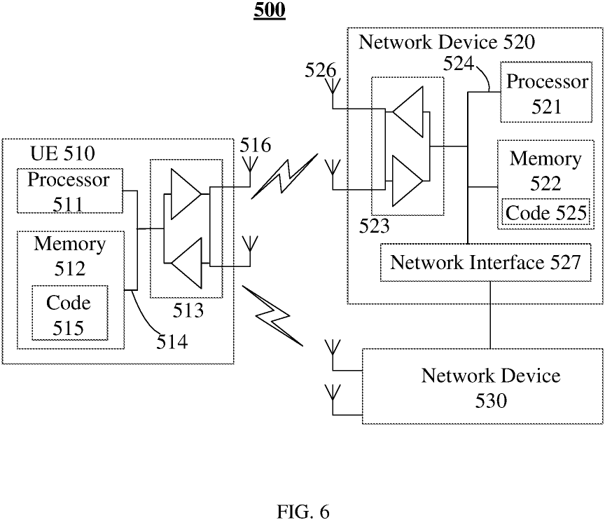

FIG. 6 illustrates a block diagram of an example communication system 500 in which embodiments of the present disclosure can be implemented. As shown in FIG. 6, the communication system 500 may comprise user equipment (UE) 510 which may be implemented as the UE 110 discussed above, a network device 520 which may be implemented as the gNB 120 discussed above, and a network device 530 which may be implemented as the gNB 130 discussed above. As the network device 530 may comprise substantially the same structural blocks as the network device 520, FIG. 6 shows only the blocks in the network device 520 and blocks in the network device 530 are not shown in FIG. 6.

Referring to FIG. 6, the UE 510 may comprise one or more processors 511, one or more memories 512 and one or more transceivers 513 interconnected through one or more buses 514. The one or more buses 514 may be address, data, or control buses, and may include any interconnection mechanism such as series of lines on a motherboard or integrated circuit, fiber, optics or other optical communication equipment, and the like. Each of the one or more transceivers 513 may comprise a receiver and a transmitter, which are connected to one or more antennas 516 such as one or more massive MIMO antenna arrays. The UE 510 may wirelessly communicate with the network devices 520, 530 through the one or mroe antennas 516. For example, the UE 510 may communicate simultaneously with both the network device 520 and the network device 530 in a dual connectivity mode as discussed above. The one or more memories 512 may include computer program code 515. The one or more memories 512 and the computer program code 515 may be configured to, when executed by the one or more processors 511, cause the user equipment 510 to perform processes and steps relating to the UE 110 as described above.

The network device 520 may comprise one or more processors 521, one or more memories 522, one or more transceivers 523 and one or more network interfaces 527 interconnected through one or more buses 524. The one or more buses 524 may be address, data, or control buses, and may include any interconnection mechanism such as a series of lines on a motherboard or integrated circuit, fiber, optics or other optical communication equipment, and the like. Each of the one or more transceivers 523 may comprise a receiver and a transmitter, which are connected to one or more antennas 526 such as one or more massive MIMO antenna arrays. The network device 520 may operate as a master base station for the UE 510 and wirelessly communicate with the UE 510 through the one or mroe antennas 526. The one or more network interfaces 527 may provide wired or wireless communication links through which the network device 520 may communicate with the network device 530 or other network entities/functions. For example, the one or more network interfaces 527 may provide a Xn link for communication with the network device 530. The one or more memories 522 may include computer program code 525. The one or more memories 522 and the computer program code 525 may be configured to, when executed by the one or more processors 521, cause the network device 520 to perform processes and steps relating to the gNB 120 as described above.

As discussed above, the network device 530 may comprise the same structural blocks as the network device 520. The network device 530 may be configured to perform substantially the same processes or steps as the network device 520, except that the network device 520 may operate as a master base station for the UE 510, while the network device 530 may operate as a secondary base station for the UE 510.

The one or more processors 511, 521 discussed above may be of any appropriate type that is suitable for the local technical network, and may include one or more of general purpose processors, special purpose processor, microprocessors, a digital signal processor (DSP), one or more processors in a processor based multi-core processor architecture, as well as dedicated processors such as those developed based on Field Programmable Gate Array (FPGA) and Application Specific Integrated Circuit (ASIC). The one or more processors 511, 521 may be configured to control other elements of the UE/network device and operate in cooperation with them to implement the procedures discussed above.

The one or more memories 512, 522 may include at least one storage medium in various forms, such as a volatile memory and/or a non-volatile memory. The volatile memory may include but not limited to for example a random access memory (RAM) or a cache. The non-volatile memory may include but not limited to for example a read only memory (ROM), a hard disk, a flash memory, and the like. Further, the one or more memories 512, 522 may include but not limited to an electric, a magnetic, an optical, an electromagnetic, an infrared, or a semiconductor system, apparatus, or device or any combination of the above.

It would be understood that blocks in FIGS. 2-3, 5-6 may be implemented in various manners, including software, hardware, firmware, or any combination thereof. In some embodiments, one or more blocks may be implemented using software and/or firmware, for example, machine-executable instructions stored in the storage medium. In addition to or instead of machine-executable instructions, parts or all of the blocks in FIGS. 2-3, 5-6 may be implemented, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-Chip systems (SOCs), Complex Programmable Logic Devices (CPLDs), etc.

Some exemplary embodiments further provide computer program code or instructions which, when executed by one or more processors, may cause a device or apparatus to perform the procedures described above. The computer program code for carrying out procedures of the exemplary embodiments may be written in any combination of one or more programming languages. The computer program code may be provided to one or more processors or controllers of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

Some exemplary embodiments further provide a computer program product or a computer readable medium having the computer program code or instructions stored therein. The computer readable medium may be any tangible medium that may contain, or store a program for use by or in connection with an instruction execution system, apparatus, or device. The machine readable medium may be a machine readable signal medium or a machine readable storage medium. A machine readable medium may include but is not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in a language that is specific to structural features and/or method actions, it is to be understood the subject matter defined in the appended claims is not limited to the specific features or actions described above. On the contrary, the above-described specific features and actions are disclosed as an example of implementing the claims.

1. A method for cell activation comprising:
receiving, at a terminal device, a first indication from a network to activate a cell configured for the terminal device; and
responsive to the first indication, triggering a beam information reporting for the cell.

2. The method of claim 1 wherein the beam information reporting is performed with a beam failure recovery procedure for the cell.

3. The method of claim 1 wherein the cell is configured as a secondary cell for carrier aggregation, on the terminal device.

4. The method of claim 1 wherein triggering a beam information reporting for the cell comprises triggering the beam information reporting for the cell upon determining at least one of following conditions:
the terminal device has received a second indication from the network to perform the beam information reporting for the cell activation;
the cell to be activated was in a deactivated state before the activation thereof;
a first active downlink bandwidth part of the cell to be activated is in a non-dormant state; or
a reference signal for beam failure detection is configured on the cell to be activated.

5. The method of claim 4 wherein the terminal device triggers the beam information reporting for the cell in a case where the terminal device has received the second indication from the network to perform the beam information reporting for the cell activation, even if the first active downlink bandwidth part of the cell to be activated is in a dormant state.

6. The method of claim 4 wherein the first indication is configured in at least one of a cell activation command or a cell configuration received from the network, and the second indication is configured in at least one of the cell activation command, the cell configuration, or a beam failure recovery configuration received from the network.

7. The method of claim 4 wherein the second indication is configured on a per cell basis, a per cell group basis, or a per terminal device basis.

8. The method of claim 1 further comprising sending a beam failure recovery medium access control (MAC) control element comprising a candidate reference signal identity for the cell to the network.

9. The method of claim 8 wherein the terminal device operates according to scheduling from the cell after sending the beam failure recovery MAC control element.

10. The method of claim 8 wherein the candidate reference signal identity comprises an index of a Synchronization Signal and Physical Broadcast Channel block (SSB) for the cell, or the candidate reference signal identity comprises one of the index of the SSB for the cell or an index of an reference signal included in a candidate reference signal list provided from the network to the terminal device, and the beam failure recovery MAC control element further comprises a third indication to indicate if the SSB index or the candidate RS reference signal list index is used as the candidate reference signal identity.

11. A method for cell activation comprising:
sending from a network to a terminal device a first indication to activate a cell configured for the terminal device;
receiving from the terminal device a beam failure recovery medium access control (MAC) control element comprising a candidate reference signal identity for the cell, the candidate reference signal identity comprising:
an index of a Synchronization Signal and Physical Broadcast Channel block (SSB) for the cell, or
one of the index of the SSB for the cell or an index of an reference signal included in a candidate reference signal list provided from the network to the terminal device, the beam failure recovery MAC control element further comprising a second indication to indicate if the SSB index or the candidate reference signal list index is used as the candidate reference signal identity; and decoding the candidate reference signal identity in the beam failure recovery MAC control element.

12. The method of claim 11 further comprising sending a third indication to the terminal device to trigger a beam information reporting for the cell activation before or at the time of sending the first indication.

13. The method of claim 12 wherein the first indication is configured in at least one of a cell activation command or a cell configuration sent from the network to the terminal device, and
the third indication is configured in at least one of the cell activation command, the cell configuration, or a beam failure recovery configuration sent from the network to the terminal device.

14. The method of claim 13 wherein the third indication is configured on a per cell basis, a per cell group basis or a per terminal device basis.

15. The method of claim 11 wherein the beam information reporting is performed with a beam failure recovery procedure for the cell.

16. The method of claim 11 wherein the cell is configured as a secondary cell for carrier aggregation on the terminal device.

17. A terminal device comprising:
at least one processor; and
at least one non-transitory memory storing instructions that, when executed with the at least one processor, cause the apparatus at least to perform:
receiving a first indication from a network to activate a cell configured for the terminal device; and
responsive to the first indication, triggering a beam information reporting for the cell.

18. The terminal device of claim 17 wherein the beam information reporting is performed with a beam failure recovery procedure for the cell.

19. The terminal device of claim 17 wherein the cell is configured as a secondary cell for carrier aggregation on the terminal device.

20. The terminal device of claim 17 wherein the at least one memory and the computer program code are configured to, with the at least one processor, cause the terminal device to trigger the beam information reporting for the cell upon determining at least one of following conditions:
the terminal device has received a second indication from the network to perform the beam information reporting for the cell activation;
the cell to be activated was in a deactivated state before the activation thereof;
a first active downlink bandwidth part of the cell to be activated is in a non-dormant state; or
a reference signal for beam failure detection is configured on the cell to be activated.

21. The terminal device of claim 20 wherein the terminal device triggers the beam information reporting for the cell in a case where the terminal device has received the second indication from the network to perform the beam information reporting for the cell activation, even if the first active downlink bandwidth part of the cell to be activated is in a dormant state.

22. The terminal device of claim 20 wherein the first indication is configured in at least one of a cell activation command or a cell configuration received from the network, and
the second indication is configured in at least one of the cell activation command, the cell configuration, or a beam failure recovery configuration received from the network.

23. The terminal device of claim 20 wherein the second indication is configured on a per cell basis, a per cell group basis, or a per terminal device basis.

24. The terminal device of claim 17 wherein the at least one memory and the computer program code are further configured to, with the at least one processor, cause the terminal device at least to perform:
sending a beam failure recovery medium access control (MAC) control element comprising a candidate reference signal identity for the cell to the network.

25. The terminal device of claim 24 wherein the terminal device operates according to scheduling from the cell after sending the beam failure recovery MAC control element.

26. The terminal device of claim 24 wherein the candidate reference signal identity comprises an index of a Synchronization Signal and Physical Broadcast Channel block (SSB) for the cell, or the candidate reference signal identity comprises one of the index of the SSB for the cell or an index of an reference signal included in a candidate reference signal list provided from the network to the terminal device, and the beam failure recovery MAC control element further comprises a third indication to indicate if the SSB index or the candidate reference signal list index is used as the candidate reference signal identity.

27. A network device comprising:
at least one processor; and
at least one non-transitory memory storing instructions that, when executed with the at least one processor, cause the apparatus at least to perform:
sending to a terminal device a first indication to activate a cell configured for the terminal device;
receiving from the terminal device a beam failure recovery medium access control (MAC) control element comprising a candidate reference signal identity for the cell, the candidate reference signal identity comprising:
an index of a Synchronization Signal and Physical Broadcast Channel block (SSB) for the cell, or one of the index of the SSB for the cell or an index of an reference signal included in a candidate reference signal list provided from a network to the UE terminal device, the beam failure recovery MAC CE control element further comprising a second indication to indicate if the SSB index or the candidate reference signal list index is used as the candidate reference signal identity; and
decoding the candidate reference signal identity in the beam failure recovery MAC control element.

28. The network device of claim 27 wherein the at least one memory and the computer program code are further configured to, with the at least one processor, cause the network device at least to perform:
sending a third indication to the terminal device to trigger a beam information reporting for the cell activation before or at the time of sending the first indication.

29. The network device of claim 28 wherein the first indication is configured in at least one of a cell activation command or a cell configuration sent from the network to the terminal device, and the third indication is configured in at least one of the cell activation command, the cell configuration, or a beam failure recovery configuration sent from the network to the terminal device.

30. The network device of claim 29 wherein the third indication is configured on a per cell basis, a per cell group basis or a per terminal device basis.

31. The network device of claim 27 wherein the beam information reporting is performed with a beam failure recovery procedure for the cell.

32. The network device of claim 27 wherein the cell is configured as a secondary cell for carrier aggregation on the terminal device.

33-41. (canceled)

42. A non-transitory computer readable medium having instructions stored thereon, the instructions, when executed with at least one processor of a terminal device, causing the terminal device to perform the method of claim 1.

43. A non-transitory computer readable medium having instructions stored thereon, the instructions, when executed with at least one processor of a device, causing the device to perform the method of claim 11.
